(19) United States
(12) Patent Application Publication
(10) Pub. No.: US 2007/0227643 A1
(43) Pub. Date: Oct. 4, 2007

(54) Internal electrode paste, multilayer ceramic electronic device and the production method

(75) Inventors: Yasushi Iijima, Narita (JP); Shigeki Sato, Narita (JP); Tomoko Nakamura, Narita (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/727,111

(22) Filed: Mar. 23, 2007

(30) Foreign Application Priority Data
Mar. 31, 2006 (JP) 2006-096663

(51) Int. Cl. C03B 29/00

(52) U.S. Cl. 156/89.12; 501/134

(57) ABSTRACT

An object of the present invention is to provide internal electrode paste capable of preventing dripping and blurring, etc. of paste even when a solvent ratio is increased and an electrode material powder ratio is decreased in the paste and, moreover, capable of forming a uniform internal electrode layer without any printing unevenness so as to obtain a thin internal electrode layer: comprising an electrode material powder, a solvent and a binder resin; wherein a molecular structure of the binder resin comprises both of a first structure unit (an acetal group derived from acetaldehyde) and a second structure unit (a butyral group derived from butylaldehyde).

### BACKGROUND OF THE INVENTION

1. Field of the Invention

The present invention relates to internal electrode paste, a multilayer ceramic electronic device produced by using the internal electrode paste, and a production method of the multilayer ceramic electronic device.

2. Description of the Related Art

A multilayer ceramic capacitor as an example of multilayer ceramic electronic devices has the configuration that a plurality of dielectric layers and internal electrode layers are alternately stacked. When producing this type of a multilayer ceramic capacitor of this kind, normally, green sheets are stacked via internal electrode layers to form a multilayer body. A green chip obtained by cutting the multilayer body into a predetermined size is subjected to binder removal processing, firing processing and a thermal treatment so as to obtain a sintered body. Terminal electrodes are formed on the sintered body to result in a capacitor.

In a production method of the related art, an internal electrode layer is formed by printing internal electrode paste including an electrode material powder, solvent and binder resin in a predetermined pattern on a green sheet or a carrier sheet. As the internal electrode paste, paste including a polyvinyl butyral resin is often used (refer to the patent article 1).

In recent years, as electronic apparatuses become downsized and have higher performance, multilayer ceramic capacitors have been required to be downsized and to have a larger capacity. To attain downsizing and a larger capacity of a multilayer ceramic capacitor, a method of making a thickness of a green sheet and internal electrode layer thinner and increasing the number of stacked layers may be considered.

To make an internal electrode layer thinner, a quantity of electrode material powders adhered per unit area has to be decreased when printing internal electrode paste on a sheet. To decrease the adhering quantity of the electrode material powder per unit area, normally, a content ratio of a solvent in the internal electrode paste is heightened and that of the electrode material powder is lowered.

However, when heightening the ratio (content ratio) of the solvent to lower the ratio (content ratio) of the electrode material powder in the internal electrode paste, the paste viscosity abruptly declines. It results in dripping and blurring, etc. of the paste when printing the internal electrode paste. Also, a printing unevenness arises due to a decline of the paste viscosity and the formation of a uniform electrode pattern may be failed. [Patent Article 1] The Japanese Unexamined Patent Publication No. 2006-012690

### SUMMARY OF THE INVENTION

An object of the present invention is to provide internal electrode paste having an excellent printing property capable of preventing dripping and blurring, etc. of paste and forming a uniform internal electrode layer without any printing unevenness even when the electrode material powder ratio is decreased by increasing a solvent ratio in the paste to obtain a thinner internal electrode layer, a multilayer ceramic electronic device produced by using the above paste and the production method.

To attain the above object, according to the present invention, there is provided internal electrode paste, comprising

an electrode material powder,

a solvent, and

a binder resin;

wherein a molecular structure of the binder resin comprises both of a first structure unit expressed by the chemical formula (I) below and a second structure unit expressed by a chemical formula (II) below.

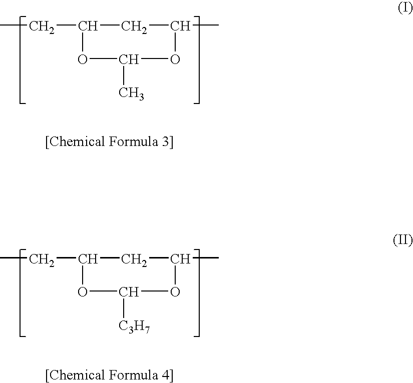

As a result that the molecular structure of the binder resin included in the internal electrode paste comprises both of a first structure unit expressed by the chemical formula (I) and a second structure unit expressed by the chemical formula (II), even when the solvent ratio is increased and the electrode material powder ratio is decreased in the a internal electrode paste, the paste viscosity can be improved. Consequently, dripping and blurring of the paste, and a printing unevenness (unevenness of an adhering quantity of printing) can be prevented at the time of printing the internal electrode paste, and a thin and uniform internal electrode layer can be formed.

Preferably, mole % Ac of the first structure unit and mole % Bu of the second structure unit in the binder resin satisfy a relationship of 0<Ac/(Ac+Bu)<1.0, and more preferably, that of 0.3≦AC/(Ac+Bu)≦1.0.

By setting Ac/(Ac+Bu) to be in the above range, viscosity of the internal electrode paste can be kept in a suitable range for printing even when the solvent ratio is increased and the electrode material powder ratio is decreased in the paste. As a result, problems at the time of printing the internal electrode paste such as dripping and blurring of the paste, and a printing unevenness (unevenness of an adhering quantity of printing), can be prevented at the time of printing the internal electrode paste, and a thin and uniform internal electrode layer can be formed. Note that, in the present invention, the mole % Ac of the first structure unit (mole % Bu of the second structure unit) is a ratio of the number of the first structure unit (a ratio of the number of the second structure unit) to the total number of the first structure unit and the second structure unit in the binder resin.

Preferably, a polymerization degree of the binder resin is 2400 to 2600.

When the solvent ratio is increased and the electrode material powder ratio is decreased in the paste to attain a thinner internal electrode layer, the paste viscosity tends to decline. However, as a result that the internal electrode layer paste includes a binder resin having the above polymerization degree, the paste viscosity can be improved. As a result, dripping, blurring, and an unevenness of an adhering quantity of printing paste can be prevented at the time of printing the internal electrode paste. Therefore, a thin and uniform internal electrode layer without any printing unevenness can be formed.

A content ratio of the electrode material powder in the internal electrode paste is preferably 30 to 55 wt %, more preferably 35 to 45 wt %, and furthermore preferably 40 to 43 wt %. Also, preferably, the electrode material powder includes Ni.

By setting a content ratio of the electrode material powder in the internal electrode paste to be in the above range, a thin inner electrode layer can be formed. Furthermore, the formed internal electrode layer has a uniform thickness and sufficient effective area.

Preferably, an average particle diameter of the electrode material powder is 0.01 to 0.3 μm.

Preferably, an acetalization degree indicating a content ratio of the first structure unit and the second structure unit in the binder resin is 60 to 82 mole %.

Preferably, a content of the binder resin in the internal electrode paste is 2 to 5 parts by weight per 100 parts by weight of the electrode material powder.

By setting the content of the binder resin to be in the above range, a decline of strength of a coated film formed by the internal electrode paste can be prevented. Also, a decline of filling density of the electrode material powder in the coated film can be prevented, and a decrease of an effective area of an internal electrode layer formed after firing can be prevented.

Preferably, the solvent includes dihydroterpineol or terpineol.

By using dihydroterpineol or terpineol as the solvent, solubility of the binder resin, a suitable viscosity characteristic of the internal electrode paste, and a suitable drying property of the paste after printing can be obtained.

Preferably, when a shear rate for the internal electrode paste is 1000 to 10000 [1/s],

a normal force by the Weissenberg effect of the internal electrode paste is 0.01 to 6.4 kPa.

By setting the normal force by the Weissenberg effect to be in the above range, a printing unevenness (unevenness of an adhering quantity of printing) can be prevented, and a thin internal electrode layer having a uniform thickness can be formed.

Preferably, the first structure unit is formed by acetalizing a part of a polyvinyl alcohol molecule by acetaldehyde, and the second structure unit is formed by acetalizing a part of the polyvinyl alcohol molecule by butylaldehyde.

By acetalizing a polyvinyl alcohol molecule by acetaldehyde and butylaldehyde, a binder resin having the first structure unit and the second structure unit can be formed.

Preferably, the internal electrode paste comprises a plasticizer, and a content of the plasticizer in the internal electrode paste is 25 to 100 parts by weight per 100 parts by weight of the binder resin. Also, preferably, the plasticizer is dioctyl phthalate.

Preferably, the internal electrode paste comprises a ceramic powder. Also, preferably, the ceramic powder includes barium titanate.

A multilayer ceramic electronic device according to the present invention is produced by using the above internal electrode paste.

According to the present invention, there is provided a production method of a multilayer ceramic electronic device, comprising the steps of:

preparing the internal electrode paste as set forth in claim 1;

molding a green sheet;

forming an internal electrode layer by using the internal electrode paste;

obtaining a green chip by stacking the green sheets and internal electrode layers; and

firing the green chip.

### BRIEF DESCRIPTION OF DRAWINGS

These and other objects and features of the present invention will become clearer from the following description of the preferred embodiments given with reference to the attached drawings, in which:

FIG. 1 is a schematic sectional view of a multilayer ceramic capacitor according to an embodiment of the present invention;

FIG. 2A to FIG. 2C are sectional views of a key part showing a transfer method of an internal electrode layer according to an embodiment of the present invention; and

FIG. 3A to FIG. 3C are sectional views of a key part showing a stacking method of internal electrode layers and green sheets according to an embodiment of the present invention.

### EXPLANATION OF THE SYMBOLS

2 . . . multilayer ceramic capacitor
4 . . . capacitor element body
6, 8 . . . terminal electrode
10 . . . dielectric layer
10a . . . green sheet
12 . . . internal electrode layer
12a . . . internal electrode layer
20 . . . carrier sheet (support body)
24 . . . blank pattern layer
Ua and Ub . . . multilayer unit

### DESCRIPTION OF THE PREFERRED EMBODIMENT

Below, the present invention will be explained based on an embodiment shown in the drawings.

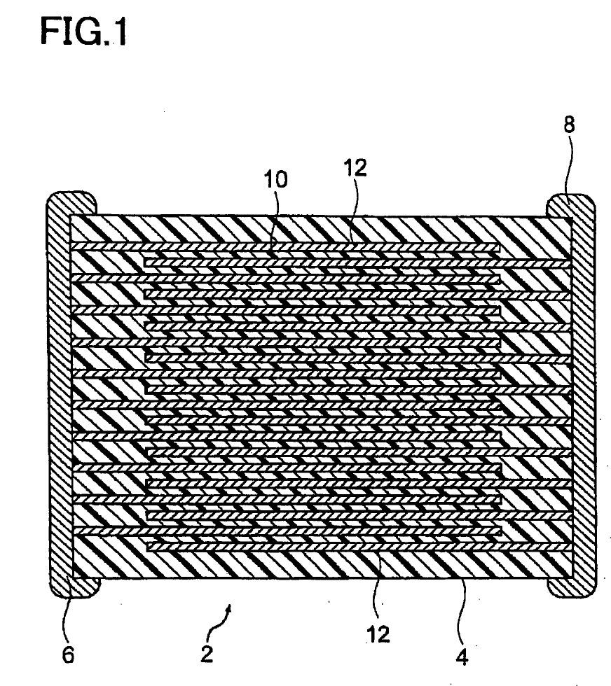

FIG. 1 is a schematic sectional view of a multilayer ceramic capacitor according to an embodiment of the present invention;

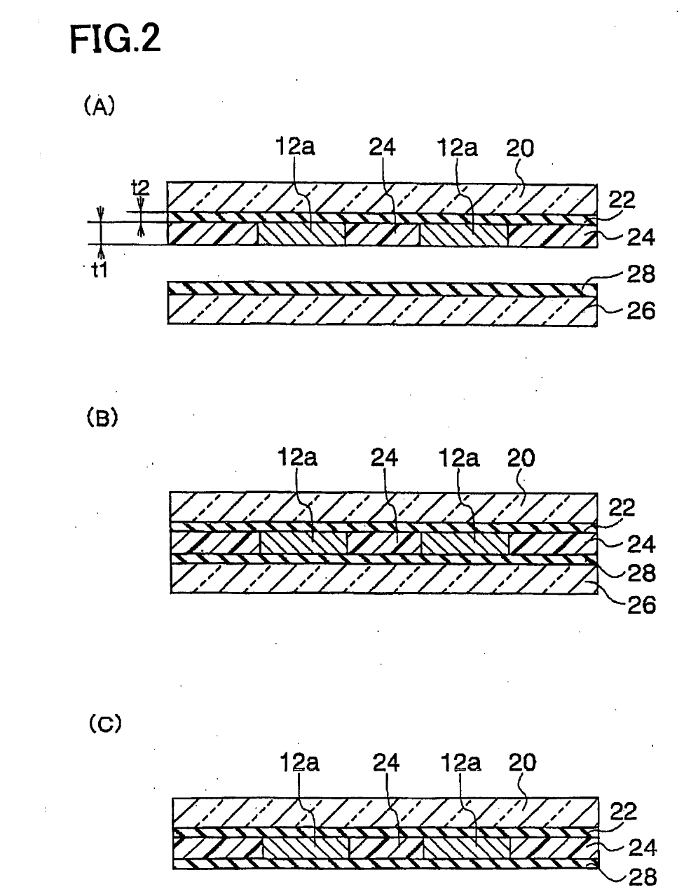

FIG. 2A to FIG. 2C are sectional views of a key part showing a transfer method of an internal electrode layer according to an embodiment of the present invention; and

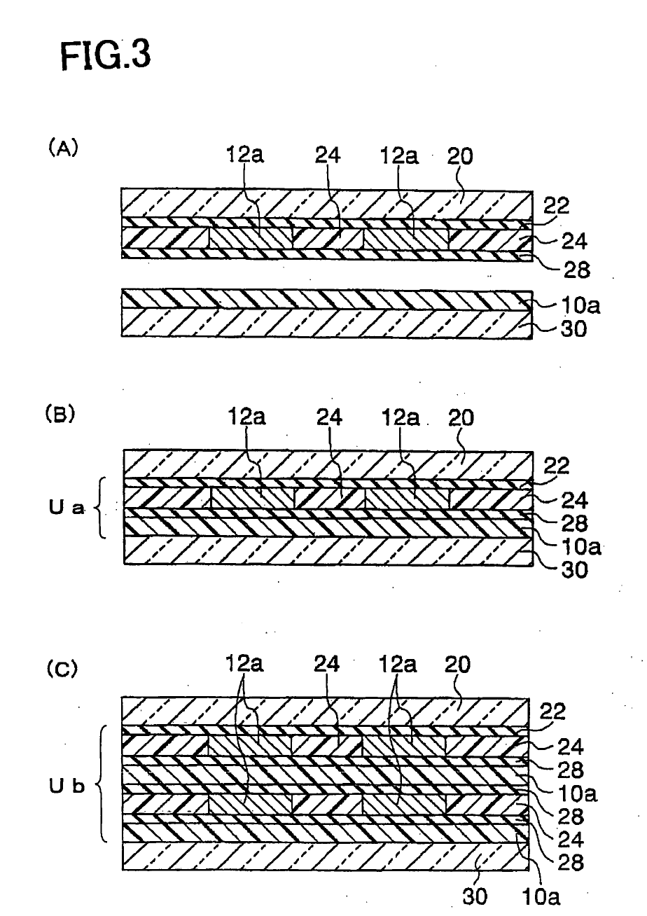

FIG. 3A to FIG. 3C are sectional views of a key part showing a stacking method of internal electrode layers and green sheets according to an embodiment of the present invention.

Overall Configuration of Multilayer Ceramic Capacitor

First, as an embodiment of the electronic device according to the present invention, an overall configuration of a multilayer ceramic capacitor will be explained.

As shown in FIG. 1, a multilayer ceramic capacitor 2 according to the present embodiment has a capacitor element body 4, a first terminal electrode 6 and a second terminal electrode 8. The capacitor element body 4 has dielectric layers 10 and internal electrode layers 12, and the internal electrode layers 12 are alternately stacked between the dielectric layers 10. One side of the alternately stacked internal electrode layers 12 is electrically connected to inside of the first terminal electrode 6 formed outside of one end portion of the capacitor element body 4. Also, the other side of the alternately stacked internal electrode layers 12 is electrically connected to inside of the second terminal electrode 8 formed outside of the other end portion of the capacitor element body 4.

A material of the dielectric layers 10 is not particularly limited and composed of a dielectric material such as calcium titanate, strontium titanate and/or barium titanate. The thickness of each dielectric layer 10 is not particularly limited but is generally several to several hundreds of μm. Particularly, in the present embodiment, it is made as thin as preferably 5 μm or thinner, more preferably 3 μm or thinner, and particularly preferably 1.0 μm or thinner. Also, the internal electrode layer 12 is made as thin as preferably 1.5 μm or thinner, more preferably 1.2 μm or thinner, and particularly preferably 1.0 μm or thinner.

A material of the terminal electrodes 6 and 8 is not particularly limited, and may be normally copper, a copper alloy, nickel and a nickel alloy, etc. Silver and an alloy of silver and palladium, etc. may be also used. Also, a thickness of the terminal electrodes 6 and 8 is not particularly limited and is normally 10 to 50 μm or so.

A shape and size of the multilayer ceramic capacitor 2 may be suitably determined in accordance with the purpose and the use. When the multilayer ceramic capacitor 2 is a rectangular parallelepiped shape, the size is normally a length (0.6 to 5.6 nm, preferably 0.6 to 3.2 mm)×width (0.3 to 5.0 mm, preferably 0.3 to 1.6 mm)×thickness (0.1 to 1.9 mm, preferably 0.3 to 1.6 nm).

Production of Multilayer Ceramic Capacitor Next, an example of production methods of the multilayer ceramic capacitor 2 according to the present embodiment will be explained.

[Formation of Release Layer]

First, as shown in FIG. 2A, a carrier sheet 20 is prepared, and a release layer 22 is formed thereon.

As the carrier sheet 20, for example a PET film, etc. is used, and those coated with silicone, etc. are preferable for improving the releasability. A thickness of the carrier sheet 20 is not particularly limited, but preferably 5 to 100 μm.

A method of coating the release layer 22 is not particularly limited, however, since it has to be formed to be extremely thin, a coating method using a wire bar coater or a die coater for instance is preferable. The release layer 22 is dried after the coating. The drying temperature is preferably 50 to 100° C., and the drying time is preferably 1 to 10 minutes.

A thickness t2 of the release layer 22 is preferably thinner than a thickness t1 of the internal electrode layer 12a, more preferably 60% of that of the internal electrode layer 12a or thinner and, furthermore preferably, 30% or thinner.

The release layer 22 includes the same dielectric particle as the dielectric composing the later explained green sheet 10a (FIG. 3A). A particle diameter of the dielectric particles may be the same as that of the dielectric particles included in the green sheet 10a, however, it is more preferable when smaller.

The release layer 22 includes a binder, a plasticizer and a release agent in addition to the dielectric particles. As the binder, the plasticizer and the release agent in the release layer 22, it is preferable to use the same kinds as those included in the later explained green sheet 10a (FIG. 3A).

The amount of the binder is preferably 2.5 to 200 parts by weight, more preferably 5 to 30 parts by weight, and particularly preferably 8 to 30 parts by weight or so per 100 parts by weight of the dielectric particles in the release layer 22.

The plasticizer is preferably included in an amount of 0 to 200 parts by weight, more preferably 20 to 200 parts by weight, and furthermore preferably 50 to 100 parts by weight per 100 parts by weight of the binder in the release layer 22.

The release agent is preferably included in an amount of 0 to 100 parts by weight, more preferably 2 to 50 parts by weight, and furthermore preferably 5 to 20 parts by weight per 100 parts by weight of the binder in the release layer 22.

[Formation of Internal Electrode Layer]

Next, as shown in FIG. 2A, an internal electrode layer 12a is formed in a predetermined pattern on a surface of the release layer 22 formed on the carrier sheet 20. The internal electrode layer 12a will compose the internal electrode layer 12 shown in FIG. 1.

A thickness t1 of the internal electrode layer 12a in FIG. 2A is preferably 0.1 to 1.5 μm, and more preferably 0.1 to 1.0 μm or so. The internal electrode layer 12a may be composed of a single layer or of two or more layers having different compositions.

A method of forming the internal electrode layers 12a includes a screen printing method, gravure printing method and other thick film method or evaporation, sputtering and other thin film method.

In the present embodiment, the internal electrode layer 12a is formed by the printing method to print the internal electrode paste in a predetermined pattern.

The internal electrode paste is fabricated by kneading a conductive material composed of a variety of conductive metals and alloys or a variety of oxides to be conductive materials when fired, an organic metal compounds, resinates or other electrode material powder with an organic vehicle and a solvent. Also, the internal electrode paste preferably includes the same ceramic powder (co-material) as that included in the later explained green sheet paste. Furthermore, the ceramic powder (co-material) preferably includes barium titanate. As a result of the co-material included, sintering in a firing step of a metal as an electrode material powder is adequately suppressed, and an internal electrode layer 12a having a sufficient effective area can be formed.

As a conductive material (electrode material powder) used for producing the internal electrode paste, Ni, a Ni alloy or a mixture of these is preferably used. A shape of conductive material is sphere, scale, etc., but is not particularly limited. Also, a mixture of these shapes may be used. An average particle diameter of the electrode material powder is normally 0.01 to 2 μm, and more preferably 0.01 to 0.3 μm or so when the shape is sphere.

A content ratio of the electrode material powder (conductive material) in the internal electrode paste is preferably 30 to 55 wt %, more preferably 35 to 45 wt %, and furthermore preferably 40 to 43 wt %.

By setting the content ratio of the electrode material powder in the internal electrode paste to be in the above range, a thin internal electrode layer 12a can be formed. Furthermore, the formed internal electrode layer has a uniform thickness and sufficient effective area.

In a region where a content ratio of the electrode material powder (conductive material) is too low, a part of the internal electrode layer 12a may be spheroidized to swell in the thickness direction in a later explained firing step of the green chip. Namely, the electrode material powder (metal powder) included in the internal electrode layer 12a tries to be stabilized by decreasing the surface area. The thinner the internal electrode layer 12a becomes, the more this phenomenon contributes to an increase of the layer thickness. Namely, the effect of making the internal electrode layer 12a thinner declines along with lowering the content ratio of the electrode material powder.

Also, in the green chip firing step, metal particles composing the internal electrode layer 12a move inside the layer. The thinner the internal electrode layer 12a becomes, a space generated after a metal particle moves becomes more unignorable. Namely, due to the space, breaking arises in the internal electrode layer 12 (FIG. 1) in the multilayer ceramic capacitor and an effective area of the internal electrode layer 12 becomes smaller. As a result, it is liable that a sufficient capacitance cannot be obtained in the capacitor.

By setting the content ratio of the electrode material powder (conductive material) in the internal electrode paste to be 30 wt % or higher, these disadvantages can be prevented.

An organic vehicle includes a binder resin and a solvent. The binder resin generally includes ethyl cellulose, an acrylic resin, polyvinyl butyral, polyvinyl acetal, polyvinyl alcohol, polyolefin, polyurethane, polystyrene or copolymers of these. In the present embodiment, the binder resin below is preferably used.

The binder resin to be used in the present embodiment preferably comprises both of a first structure unit (a structure unit having an acetal group) expressed by the above chemical formula (I) and a second structure unit (structure unit having a butyral group) expressed by the above chemical formula (II).

Preferably, the first structure unit is formed by acetalizing a part of a polyvinyl alcohol molecule by acetaldehyde. Also preferably, the second structure unit is formed by acetalizing (namely, butyralizing) a part of a polyvinyl alcohol molecule by butylaldehyde.

Namely, a binder resin according to the present embodiment is generated by adding acetaldehyde, butylaldehyde and an acid catalyst to an aqueous solution of a polyvinyl alcohol resin to bring acetalization reaction by a well-known method. The acetalization reaction is stopped by a terminator.

The polyvinyl alcohol resin is not particularly limited and may be a vinyl alcohol such as an ethylene-vinyl alcohol copolymer resin and partially saponified ethylene-vinyl alcohol copolymer resin, a copolymer of a monomer copolymerizable with vinyl alcohol, or a denatured polyvinyl alcohol resin, wherein carbonic acid, etc. is partially introduced.

The acid catalyst is not particularly limited, and may be organic acids such as acetic acid, p-toluene sulfonic acid and inorganic acids such as nitric acids, sulfuric acids, and hydrochloric acid.

A terminator of the acetalization reaction is not particularly limited, and may be alkali neutralizer such as sodium hydroxide, potassium hydroxide, ammonia, sodium acetate, sodium carbonate, sodium hydrogen carbonate, potassium carbonate; ethylene oxide and other alkylene oxides; and ethylene glycol diglycidyl ether and other glycidyl ethers for example.

In the present embodiment, mole % Ac of the first structure unit and mole % Bu of the second structure unit in a binder resin satisfy a relationship of preferably 0<Ac/(Ac+Bu)<1.0, and more preferably 0.3≦Ac/(Ac+Bu)≦0.9.

A ratio of mole % Ac of the first structure unit and mole % Bu of the second structure unit is equal to a mole ratio of acetaldehyde and butylaldehyde to be added as materials in the acetalization reaction explained above. Accordingly, by setting the mole ratio of acetaldehyde and butylaldehyde to be a predetermined value in the acetalization reaction of a polyvinyl alcohol resin, Ac/(Ac+Bu) in the binder resin as a reaction product can be controlled to be in the above range.

Preferably, an acetalization degree indicating a content ratio of the first and the second structure units in the binder resin is 60 to 82 mole %. Note that the acetalization degree here means an acetalization degree by acetaldehyde and butylaldehyde.

Note that an acetyl or a hydroxyl group may reside in molecules of the binder resin after the acetalization reaction.

Preferably, a polymerization degree of the binder resin is 2400 to 2600. The polymerization degree of the binder resin becomes equal to that of a polyvinyl alcohol resin to be used as a material. Accordingly, in the present embodiment, a binder resin formed by acetalizing a polyvinyl alcohol resin having a polymerization degree of 2400 to 2600 may be used. By setting the polymerization degree of the binder resin to be in this range, viscosity of an organic vehicle can be increased. Viscosity of the internal electrode paste including the organic vehicle can be also increased.

Preferably, a content of the binder resin in the internal electrode paste is 2 to 5 parts by weight per 100 parts by weight of the electrode material powder.

Preferably, when a shear rate for the internal electrode paste is 1000 to 10000 [1/s], a normal force by the Weissenberg effect of the internal electrode paste is 0.01 to 6.4 kPa. The normal force by the Weissenberg effect of the internal electrode paste is measured by using a viscoelasticity measuring instrument (rheometer), etc. capable of measuring a normal force.

As a solvent to be included in the internal electrode paste, dihydroterpineol or terpineol is preferably used. By using dihydroterpineol or terpineol as a solvent, solubility of the binder resin to the internal electrode paste, the suitable viscosity characteristic of the paste and the suitable drying property of the paste after printing can be obtained.

A content of the solvent to be included in the internal electrode paste is not particularly limited, but is preferably 20 to 50 wt % per the entire internal electrode paste.

Preferably, the internal electrode paste includes a plasticizer to improve the adhesiveness. The plasticizer may be benzyl butyl phthalate (BBP) and other phthalate esters, adipic acid, phosphate ester and glycols, etc. may be mentioned. In the present embodiment, preferably, adipic acid dioctyl (DOA), butyl butylene glycol phthalate (BPBG), didodecyl phthalate (DDP), dibutyl phthalate (DBP), benzilbutyl phthalate (BBP), dioctyl phthalate (DOP) and dibutyl sebacate, etc. may be used. Among them, dioctyl phthalate (DOP) is particularly preferable.

The plasticizer is included in an amount of preferably 25 to 150 parts by weight and, more preferably, 25 to 100 parts by weight per 100 parts by weight of the binder resin. By adding the plasticizer, an adhesive force of an internal electrode layer 12a to be formed by using the paste is improved, and an adhesive force of the internal electrode layer 12a and a later explained green sheet 10a (FIG. 3A) is improved. To obtain such an effect, an adding quantity of the plasticizer is preferably 25 to 150 parts by weight.

[Formation of Blank Pattern Layer]

As shown in FIG. 2A, next to the internal electrode layers 12a on a surface of the release layer 22, where a pattern of the internal electrode layer 12a is not formed, a blank pattern layer 24 having substantially the same thickness as that of the internal electrode layer 12a is formed.

The blank pattern layer 24 is formed by using the same paste as that used for forming the later explained green sheet 10a (FIG. 3A). Also, the blank pattern layer 24 can be formed by the same method as that for forming the internal electrode layer 12a or green sheet 10a.

The internal electrode layer 12a and the blank pattern layer 24 are dried after being formed in accordance with need. A drying temperature of the internal electrode layer 12a and the blank pattern layer 24 is not particularly limited, but is preferably 70 to 120° C., and the drying time is preferably 1 to 10 minutes.

[Formation of Adhesive Layer]

Next, as shown in FIG. 2A, an adhesive layer 28 is formed on a surface of a carrier sheet 26. The carrier sheet 26 is composed of the same sheet as that of the carrier sheet 20.

The adhesive layer 28 is formed by a bar coater method, die coater method, reverse coater method, dip coater method and kiss coater method, etc.

The adhesive layer 23 is dried after being formed in accordance with need. The drying temperature is not particularly limited, but is preferably the room temperature to 60° C., and the drying time is preferably 1 to 5 minutes.

The adhesive layer 28 includes a binder and a plasticizer. The adhesive layer 28 may include dielectric particles having the same composition as that of a dielectric composing the green sheet 10a.

The plasticizer is included in an amount of 0 to 200 parts by weight, preferably 20 to 200 parts by weight, and more preferably 50 to 100 parts by weight in the adhesive layer 28 per 100 parts by weight of the binder.

A thickness of the adhesive layer 28 is preferably 0.02 to 0.3 μm or so and is preferably smaller than an average particle diameter of the dielectric particles included in the green sheet. Also, the thickness of the adhesive layer 28 is preferably 1/10 of that of the green sheet 10a or thinner.

Next, as shown in FIG. 2B, the adhesive layer 29 is pressed against a surface of the internal electrode layer 12a and the blank pattern layer 24, then, heated and pressurized. After that, by removing the carrier sheet 26, as shown in FIG. 2C, the adhesive layer 28 is transferred to the surface of the internal electrode layer 12a and the blank pattern layer 24.

A heating temperature at transferring is preferably 40 to 100° C., and a pressure force at transferring is preferably 0.2 to 15 MPa. The pressuring may be performed by a press or by a calendar roll.

[Formation of Green Sheet]

Next, as shown in FIG. 3A, dielectric paste (green sheet paste) is applied to a carrier sheet 30 so as to form a green sheet 10a. The green sheet 10a will compose the dielectric layers 10 shown in FIG. 1.

As a method of forming the green sheet 10a in FIG. 3A, a doctor blade method or a die coater method, etc. may be mentioned. The green sheet 10a is formed to have a thickness of preferably 0.5 to 30 μm, and more preferably 0.5 to 10 μm or so.

The green sheet 10a is dried after being formed on the carrier sheet 30. The drying temperature of the green sheet 10a is preferably 50 to 100° C., and the drying time is preferably 1 to 20 minutes. A thickness of the green sheet 10a after drying is contracted to 5 to 25% of a thickness before drying. A thickness of the dried green sheet 10a is preferably 3 μm or thinner.

The carrier sheet 30 may be the same as the carrier sheet 20 explained above.

The dielectric paste is composed of organic solvent-based paste obtained by kneading a dielectric material (ceramic powder) with an organic vehicle.

The dielectric material may be suitably selected from a variety of compounds to be composite oxides and oxides, for example, carbonates, oxalates, hydroxides and organic metal compounds, etc. and mixed for use. The dielectric material is normally used as a powder with an average particle diameter of 0.4 μm or smaller, and more preferably, 0.1 to 0.3 μm or so. Note that a finer powder than a thickness of the green sheet 10a is desirable to form an extremely thin green sheet 10a.

A binder to be used for the organic vehicle is not particularly limited and may be a variety of normal binders such as ethyl cellulose, polyvinyl butyral and an acrylic resin.

Also, an organic solvent to be used for the organic vehicle is not particularly limited, and terpineol, butyl carbitol, acetone, toluene and other organic solvent may be used.

The dielectric paste may include additives selected from a variety of dispersants, plasticizers, dielectrics, subcomponent compounds, glass flits and insulators, etc. in accordance with need. When adding these additives to the dielectric paste, the total content is preferably about 10 wt % or smaller.

[Formation of Multilayer Body Unit]

Next, as shown in FIG. 3B, the internal electrode layer 12a and the blank pattern layer 24 formed on the carrier sheet 20 are pressed against a surface of the green sheet 10a via an adhesive layer 26, then, heated and pressurized. As a result, a multilayer body unit Ua is obtained. Several multilayer body units Ua are formed.

The temperature, the pressure and the pressuring method may be the same as those in the case of transferring the adhesive layer 28 (FIG. 2B) to the surface of the internal electrode layer 12a and blank pattern layer 24.

Next, the carrier sheet 30 is removed from one multilayer body unit Ua. Also, the carrier sheet 20 is removed from another multilayer body unit Ua. Then, the both multilayer units Ua are stacked in a positional relationship that a green sheet 10a of one multilayer body unit Ua contacts with an upper surface of an internal electrode layer 12 and blank pattern layer 24 of the other multilayer body unit Ua. By repeating such stacking for several times, a multilayer body is formed.

Note that the multilayer body may be formed by using a multilayer body unit Ub (FIG. 3C) configured by stacking two multilayer body units Ua. By making the multilayer body unit thick as such, strength of the multilayer unit increases. As a result, damaging on the multilayer body unit in the stacking step can be prevented.

Next, after stacking an outer layer green sheet (a green sheet without an electrode layer formed thereon) on an upper surface and/or lower surface of the multilayer body, the multilayer body is finally pressurized. A pressure force at the final pressurizing is preferably 10 to 200 MPa. Also, the heating temperature is preferably 40 to 100° C. After that, the multilayer body is cut into a predetermined size to form a green chip.

[Binder Removal, Firing and Thermal Treatment on Green Chip]

The green chip is subjected to the binder removal processing and the firing processing followed by the thermal treatment to re-oxidize the dielectric layers.

The binder removal processing may be performed under a normal condition, but when using Ni, a Ni alloy or other base metal as a conductive material of the internal electrode layers, it is performed preferably under the condition below.

Temperature raising rate: 5 to 300° C./hour, particularly 10 to 50° C./hour

Holding temperature: 200 to 800° C., particularly 350 to 600° C.

Holding time: 0.5 to 20 hours, particularly 1 to 10 hours

Atmosphere gas: wet mixed gas of N₂ and H₂

The firing is preferably performed as below.

Temperature raising rate: 50 to 500° C./hour, particularly 200 to 300° C./hour

Holding temperature: 1100 to 1300° C., particularly 1150 to 1250° C.

Holding time: 0.5 to 0 hours, particularly 1 to 3 hours

Cooling rate: 50 to 500° C./hour, particularly 200 to 300° C./hour

Atmosphere gas: wet mixed gas of N₂+H₂, etc.

Note that an oxygen partial pressure of an air atmosphere at firing is preferably 10⁻² Pa or lower, and particularly 10⁻² to 10⁻³ Pa. When exceeding the range, the internal electrode layers tend to be oxidized, while it is liable that abnormal sintering is caused in electrode materials of the internal electrode layers to result in breaking when the oxygen partial pressure is too low.

The thermal treatment after the firing as above is performed by setting the holding temperature or the highest temperature to preferably 1000° C. or hither and, more preferably, 1000 to 1100° C. When the holding temperature or the highest temperature at the thermal treatment is lower than the above range, the oxidization of the dielectric material becomes insufficient, causing that the insulation resistance lifetime tends to become short; on the other hand, when exceeding the above range, Ni in the internal electrodes is not only oxidized to lower the capacity, but also it reacts with the dielectric base material, causing that the lifetime tends to become short. An oxygen partial pressure at the thermal treatment is higher than that in the reducing atmosphere at firing, and is preferably 10⁻³ Pa to 1 Pa and, more preferably, 10⁻² Pa to 1 Pa. When the oxygen partial pressure is lower than the above range, re-oxidization of the dielectric layers becomes difficult, while the internal electrode layers tend to be oxidized when exceeding the range. Other thermal treatment condition is preferably as below.

Holding time: 0 to 6 hours, particularly 2 to 5 hours

Cooling rate: 50 to 500° C./hour, particularly 100 to 300° C./hour

Atmosphere gas: wet N₂ gas, etc.

Note that a wetter, for example, may be used to wet the N₂ gas and mixed gas. In that case, the water temperature is preferably 0 to 75° C. or so. The binder removal processing, the firing processing and the thermal treatment may be performed continuously or separately. When performing continuously, the atmosphere is changed without cooling after the binder removal processing, followed by raising the temperature to the holding temperature for firing to perform firing; after firing, it is cooled to the holding temperature of the thermal treatment where the atmosphere is changed and the thermal treatment is preferably performed. On the other hand, when performing them separately, after raising the temperature to the holding temperature of the binder removal processing in an atmosphere of a N₂ gas or a wet N₂ gas, the atmosphere is changed, and the temperature is preferably furthermore raised for firing. After cooling the temperature to the holding temperature of the thermal treatment, it is preferable that the cooling continues by changing the atmosphere again to a N₂ gas or a wet N₂ gas. Also, in the thermal treatment, after raising the temperature to the holding temperature under the N₂ gas atmosphere, the atmosphere may be changed, or the entire process of the thermal treatment may be in a wet N₂ gas atmosphere.

End surface polishing by barrel polishing or sand blast, for example, is performed on the sintered body (element body 4 in FIG. 1) obtained as above, and the terminal electrode paste is burnt to form terminal electrodes 6 and 8. The firing of the terminal electrode paste is performed, for example, preferably at 600 to 800° C. in a wet mixed gas of N₂ and H₂ for 10 minutes to 1 hour or so. A pad layer is formed by plating, etc. on the terminal electrodes 6 and 8 if necessary. Note that the terminal electrode paste may be fabricated in the same way as the electrode paste explained above.

A multilayer ceramic capacitor 2 of the present invention produced as above is mounted on a print substrate, etc. by soldering, etc. and used for a variety of electronic apparatuses, etc.

In the present embodiment, a molecular structure of the binder resin included in the internal electrode paste comprises both of the first structure unit (structure unit derived from acetaldehyde) expressed by the above chemical formula (I) and the second structure unit (structure unit derived from butylaldehyde) expressed by the above chemical formula (II). As a result, even when the solvent ratio in the internal electrode paste is increased and the electrode material powder ratio is decreased, a decline of paste viscosity can be prevented. Accordingly, when printing the internal electrode paste, dripping, blurring and printing unevenness (unevenness of an adhering quantity of printing) can be prevented and a thin and uniform internal electrode layer 12a (FIG. 2A) can be formed.

In the present embodiment, mole % Ac of the first structure unit and mole % Bu of the second structure unit in the binder resin satisfy a relationship of preferably 0<Ac/(Ac+Bu)<1.0 and, more preferably, 0.3≦Ac/(Ac+Bu)≦0.9. As a result, even when increasing the solvent ratio and decreasing the electrode material powder ratio in the internal electrode paste, viscosity of the internal electrode paste can be maintained in a suitable range for printing. Namely, by satisfying 0<Ac/(Ac+Bu) and, preferably, 0.3≦Ac/(Ac+Bu), viscosity of the internal electrode paste can be increased, and dripping can be prevented. Also, by satisfying Ac/(Ac+Bu)<1.0 and, preferably, Ac/(Ac+Bu)≦0.9, the normal force can be suppressed to 6.4 kPa or lower, and an unevenness of the adhering quantity of printing can be decreased. As a result, dripping, blurring and a printing unevenness (unevenness of an adhering quantity of printing), etc. of the paste at the time of printing the internal electrode paste can be prevented.

In the present embodiment, by setting the polymerization degree of the binder resin to 2400 to 2600, even when increasing the solvent ratio and decreasing the electrode material powder ratio in the internal electrode paste, viscosity of the internal electrode paste can be maintained to be in a suitable range for printing. Namely, an excessive decline of the paste viscosity or an excessive increase of the normal force can be prevented. As a result, dripping, blurring and a printing unevenness (unevenness of an adhering quantity of printing), etc. of the paste at the time of printing the internal electrode paste can be prevented.

In the present embodiment, a content of the binder resin in the internal electrode paste is 2 to 5 parts by weight per 100 parts by weight of the electrode material powder. When the content of the binder resin is too small, stickiness as a binder resin declines to weaken strength of a coated film of the internal electrode paste. On the other hand, when the content of the binder resin is too large, the filling density of electrode material powders in a coated film is reduced to decline the effective area of the internal electrodes after firing. By setting the content of the binder resin within the above range, the above disadvantages can be prevented.

In the present embodiment, when a shear rate for the internal electrode paste is 1000 to 10000 [1/s], a normal force by the Weissenberg effect of the internal electrode paste is 0.01 to 6.4 kPa. By setting the normal force to 0.01 to 6.4 kPa, dripping, blurring and a printing unevenness (unevenness of an adhering quantity of printing) can be prevented, and an internal electrode layer having a uniform thin thickness can be formed.

Note that the present invention is not limited to the above embodiment, and may be variously modified within the scope of the present invention.

For example, in the above embodiment, as shown in FIG. 3A, an internal electrode layer 12a was transferred to a green sheet 10a via an adhesive layer 2B, but the internal electrode layer 12a may be directly printed on a surface of the green sheet 10a. In other words, the internal electrode layer 12a may be formed on the surface of the green sheet 10a by using a printing method. In that case, the same effects as those in the above embodiment can be also obtained.

Also, the method of the present invention is not limited to the production method of a multilayer ceramic capacitor, and it can be also applied as the production method of a multilayer inductor, multilayer substrate and other multilayer electronic devices.

### EXAMPLES

Below, the present invention will be explained based on further detailed examples, but the present invention is not limited to these examples.

### Example 1

Acetaldehyde and butylaldehyde were used to acetalize polyvinyl alcohol having a polymerization degree of 2600. A mole ratio of the acetaldehyde and butylaldehyde used for the acetalization was 4:1.

Measurement was made on the reaction product obtained by the acetalization by using a Fourier transformation infrared reflectance meter (FT-IR).

As a result, it was learnt that the reaction product was a binder resin having an acetalization degree by acetaldehyde and butylaldehyde of 71.9 mole %. Also, it was learned that the binder resin includes the first structure unit (an acetal group derived from acetaldehyde) of 57.4 mole %, the second structure unit (a butyral group derived from butylaldehyde) of 14.5 mole %, a residual acetyl group of 1.0 mole % and a hydroxyl group of 27.1 mole %.

Also, in the obtained binder resin, it was confirmed that a ratio of mole % Ac of the first structure unit and mole % Bu of the second structure unit was 4:1, and that a value of Ac/(Ac+Bu) was 0.8.

A polymerization degree of the obtained binder resin was 2600, which was the same as that of the polyvinyl alcohol before the acetalization.

The obtained binder resin, Ni particles (electrode material powder), dihydroterpineol (solvent) and ceramic powder (BaTiO₃ powder and ceramic powder subcomponent additives) were kneaded by a ball mill to form slurry, so that internal electrode paste was produced. Note that a content ratio of the Ni particles (electrode material powder) in the entire internal electrode paste was 40 wt %. Also, compounding ratios of respective components per 100 parts by weight of the electrode material powder were as below.

binder resin: 5 parts by weight

dihydroterpineol: 125 parts by weight

ceramic powder: 20 parts by weight

### Examples 2 and 3

Other than changing a polymerization degree of the binder resin to those shown in Table 1, internal electrode pastes of examples 2 and 3 were produced respectively under the same condition as that in the example 1.

TABLE 1

| | | | | | | | fluctuation | |
|---|---|---|---|---|---|---|---|---|
| | | | | | | | of an | |
| | | | | | | | adhering | |
| | | polymerization | | | | dripping | quantity of | |
| | Ac/(Ac + Bu) | degree | viscosity | | normal force | degree | printing | Comprehensive |
| | (−) | (−) | V8(1/s) | V50(1/s) | (kPa) | (cm²/g) | (%) | Evaluation |
| Comparative | 0.00 | 2000 | 3.2 | 1.8 | 0.16 | 4.8 | — | defective |
| Example 1 | | | | | | | | |
| Comparative | 0.00 | 2400 | 6.0 | 3.2 | 0.19 | 4.6 | — | defective |
| Example 2 | | | | | | | | |
| Comparative | 0.00 | 2500 | 6.4 | 3.6 | 0.24 | 4.5 | — | defective |
| Example 3 | | | | | | | | |
| Comparative | 0.00 | 2600 | 6.9 | 4.0 | 0.32 | 4.4 | — | defective |
| Example 4 | | | | | | | | |
| Comparative | 0.00 | 3000 | 7.4 | 4.3 | 0.40 | 4.3 | — | defective |
| Example 5 | | | | | | | | |
| Example20 | 0.30 | 2400 | 6.8 | 3.5 | 1.11 | 4.0 | 0.8 | good |
| Example21 | 0.30 | 2500 | 7.1 | 3.8 | 1.27 | 3.9 | 0.9 | good |
| Example22 | 0.30 | 2600 | 7.6 | 4.2 | 1.59 | 3.7 | 1.1 | good |
| Example 4 | 0.50 | 2400 | 7.2 | 4.0 | 2.39 | 3.9 | 0.8 | good |
| Example 5 | 0.50 | 2500 | 7.5 | 4.3 | 2.55 | 3.8 | 0.9 | good |
| Example 6 | 0.50 | 2600 | 7.9 | 4.4 | 3.18 | 3.7 | 1.2 | good |
| Example 7 | 0.60 | 2400 | 8.3 | 4.5 | 3.18 | 3.8 | 1.5 | good |
| Example 8 | 0.60 | 2500 | 8.7 | 4.7 | 3.34 | 3.7 | 1.6 | good |
| Example 9 | 0.60 | 2600 | 9.0 | 5.0 | 3.66 | 3.7 | 1.8 | good |
| Example 2 | 0.80 | 2400 | 9.4 | 5.2 | 4.46 | 3.6 | 2.5 | good |
| Example 3 | 0.80 | 2500 | 10.0 | 5.4 | 4.78 | 3.6 | 2.7 | good |
| Example 1 | 0.80 | 2600 | 11.0 | 6.2 | 4.78 | 3.5 | 2.9 | good |
| Example 10 | 0.85 | 2400 | 10.2 | 5.7 | 5.57 | 3.6 | 3.8 | good |
| Example 11 | 0.85 | 2500 | 12.0 | 6.3 | 5.73 | 3.5 | 4.0 | good |
| Example 12 | 0.85 | 2600 | 13.5 | 7.3 | 5.89 | 3.4 | 4.1 | good |
| Example 23 | 0.90 | 2400 | 10.5 | 6.1 | 5.89 | 3.5 | 4.3 | good |
| Example 24 | 0.90 | 2500 | 12.3 | 7.0 | 6.21 | 3.5 | 4.4 | good |
| Example 25 | 0.90 | 2600 | 14.2 | 8.2 | 6.30 | 3.4 | 4.6 | good |
| Comparative | 1.00 | 2400 | 12.2 | 7.0 | 7.32 | 3.5 | 5.5 | defective |
| Example 6 | | | | | | | | |
| Comparative | 1.00 | 2500 | 14.0 | 8.5 | 7.64 | 3.3 | 5.7 | defective |
| Example 7 | | | | | | | | |
| Comparative | 1.00 | 2600 | 16.7 | 9.3 | 8.12 | 3.3 | 6.0 | defective |
| Example 8 | | | | | | | | |

### Examples 20 to 22

A value of Ac/(Ac+Bu) in the binder resin was changed to 0.3. Also, a polymerization degree of the binder resin was changed to values shown in Table 1. Other than that, internal electrode pastes of examples 20 to 22 were produced respectively under the same condition as that in the example 1.

### Examples 4 to 6

A value of Ac/(Ac+Bu) in the binder resin was changed to 0.5. Also, a polymerization degree of the binder resin was changed to values shown in Table 1. Other than that, internal electrode pastes of examples 4 to 6 were produced respectively under the same condition as that in the example 1.

### Examples 7 to 9

A value of Ac/(Ac+Bu) in the binder resin was changed to 0.6. Also, a polymerization degree of the binder resin was changed to values shown in Table 1. Other than that, internal electrode pastes of examples 7 to 9 were produced respectively under the same condition as that in the example 1.

### Examples 10 to 12

A value of Ac/(Ac+Bu) in the binder resin was changed to 0.85. Also, a polymerization degree of the binder resin was changed to values shown in Table 1. Other than that, internal electrode pastes of examples 10 to 12 were produced respectively under the same condition as that in the example 1.

### Examples 23 to 25

A value of Ac/(Ac+Bu) in the binder resin was changed to 0.9. Also, a polymerization degree of the binder resin was changed to values shown in Table 1. Other than that, internal electrode pastes of examples 23 to 25 were produced respectively under the same condition as that in the example 1.

### Comparative Examples 1 to 5

A value of Ac/(Ac+Bu) in the binder resin was changed to 0. Namely, polyvinyl alcohol was acetalized only by butylaldehyde to obtain a polyvinyl butyral resin. The result was used as a binder resin. Also, a polymerization degree of the polyvinyl butyral resin was changed to values shown in Table 1. Other than that, internal electrode pastes of comparative examples 1 to 5 were produced respectively under the same condition as that in the example 1.

### Comparative Examples 6 to 8

A value of Ac/(Ac+Bu) in the binder resin was changed to 1.0. Namely, polyvinyl alcohol was acetalized only by acetaldehyde to obtain a polyvinyl acetal resin. The result was used as a binder resin. Also, a polymerization degree of the polyvinyl acetal resin was changed to values shown in Table 1. Other than that, internal electrode pastes of comparative examples 6 to 8 were produced respectively under the same condition as that in the example 1.

### Examples 13 to 19

Other than changing a content ratio of Ni particles (electrode material powder) in entire internal electrode paste to values shown in Table 2, internal electrode pastes of examples 13 to 19 were produced respectively under the same condition as that in the example 1.

Next, each internal electrode paste was printed on a support sheet to form a plurality of internal electrode layers.

Next, a dielectric material (ceramic powder), an organic vehicle, a solvent, a dispersant and a plasticizer were mixed at a predetermined ratio and kneaded to produce dielectric paste (green sheet paste).

Next, the dielectric paste was used to form a plurality of green sheets.

Next, these green sheets were stacked via internal electrode layers, so that a multilayer body was obtained. After pressuring the multilayer body while heating, the result was cut into a predetermined size and a green chip was obtained.

After performing binder removal processing, firing processing and thermal treatment on the green chip, terminal electrodes were formed on end portions of the obtained fired body, so that multilayer ceramic capacitors 2 (FIG. 1) of the examples 13 to 19 were obtained. In the examples 13 to 19, a printed thickness of the internal electrode and a thickness of internal electrode layer in the multilayer ceramic capacitor were measured. The results are shown in Table 2.

TABLE 2

| | content ratio of the | printing | thickness of an |
|---|---|---|---|
| | electrode material powder | thickness | internal electrode |
| | (metal) (%) | (μm) | layer (μm) |
| Example 13 | 55 | 1.44 | 1.18 |
| Example 14 | 50 | 1.20 | 0.98 |
| Example 15 | 45 | 0.91 | 0.73 |
| Example 16 | 43 | 0.82 | 0.66 |
| Example 17 | 40 | 0.69 | 0.57 |
| Example 18 | 35 | 0.54 | 0.46 |
| Example 19 | 33 | 0.49 | 0.44 |

### Evaluation

[Viscosity of Internal Electrode Paste]

On each of internal electrode paste of the examples 1 to 12 and 20 to 25 and comparative examples 1 to 8, viscosity was measured. The results are shown in Table 1. Note that a parallel-plate type viscometer was used for the measurement. In a state where a temperature of internal electrode paste was 25° C., viscosity (V8(1/s)) when applied a rotation with a shear rate of 8 [1/s] and viscosity (V50(1/s)) when applied a rotation with a shear rate of 50 [1/s] were measured.

[Normal force of Internal Electrode Paste]

On each of internal electrode paste of the examples 1 to 12 and 20 to 25 and comparative examples 1 to 8, a normal force (maximum value) by the Weissenberg effect was measured. The results are shown in Table 1. Note that a viscoelasticity measuring instrument (rheometer), etc. capable of measuring a normal force was used in the measurement. A normal force of internal electrode paste was measured under a condition that a diameter of a pair of parallel plates (circular) was 40 mm, a distance between the plates is 300 μm, a temperature of internal electrode paste was 25° C., and a shear rate for internal electrode paste was 1000 to 10000 [1/s].

[Dripping Degree of Internal Electrode Paste]

On each of internal electrode paste of the examples 1 to 12 and 20 to 25 and comparative examples 1 to 8, “a dripping degree” was measured. The results are shown in Table 1. Note that the “dripping degree” was measured as below. First, a metal cylinder having an inner diameter of φ20 nm was put on a horizontally placed flat glass plate, and 5 g of internal electrode paste was poured in the cylinder. Then, the metal cylinder was pulled up vertically. When the metal cylinder was pulled up, the internal electrode paste loosing from a restraint by an inner wall of the cylinder spread out on the glass. After two minutes from the pulling up of the metal cylinder, an area of the internal electrode paste spread from the original cylinder bottom area was obtained. A value obtained by dividing the area by weight of the paste put on the glass plate was considered as “a dripping degree” (cm²/g). Easily dripping paste, that is, internal electrode paste having a large “dripping degree” spreads wider in a certain time. When the “dripping degree” exceeds 4 cm²/g, the backside and blurs of the paste becomes notable at screen printing of the internal electrode paste to make printing difficult. Therefore, the dripping degree is preferably 4 cm²/g or lower.

[Fluctuation of Adhering Quantity of Printing Internal Electrode Paste]

On each of internal electrode paste of the examples 1 to 12 and 20 to 25 and comparative examples 1 to 8, a fluctuation of an adhering quantity of printing internal electrode paste was measured. The results are shown in Table 1. Note that, in the measurement, a sliding speed of a squeegee at screen printing of internal electrode paste was changed in a range of 0.5 to 2 times of a speed at normal printing. At each speed, internal electrode paste was printed to have a thickness of 0.5 μm on a surface of a PET film and the adhering quantity (g) of printing was measured. As the sliding speed of the squeegee changed, the adhering quantity of printing also changed. Therefore, based on an adhering quantity of printing at a sliding speed of a squeegee used at normal printing, a fluctuation (%) of the adhering quantity of printing was calculated. The adhering quantity of printing has little change in internal electrode paste having a preferable printing property even when a sliding speed of the squeegee is changed, and the fluctuation became nearly 0%. The fluctuation becomes large in internal electrode paste having a poor printing property. When the fluctuation exceeds 5%, it becomes difficult to keep the printing condition (a layer thickness) constant and to continue printing. Namely, a fluctuation of an adhering quantity of printing internal electrode paste is preferably 5% or lower.

Comprehensive Evaluation

On each internal electrode paste of the examples 1 to 12 and 20 to 25 and comparative examples 1 to 8, those exhibited a normal force by the Weissenberg effect of out of a range of 0.01 to 6.4 kPa, those exhibited a “dripping degree” of larger than 4 cm²/g, or those exhibited a fluctuation of an adhering quantity of printing of higher than 5% were evaluated “defective” in the comprehensive evaluation. On the other hand, those exhibited a normal force of 0.01 to 6.4 kPa, a “dripping degree” of 4 cm²/g or lower and a fluctuation of an adhering quantity of printing of 5% or lower were evaluated “good” in the comprehensive evaluation. The results are shown in Table 1. When using “defective” internal electrode paste, dripping and blurring, and a printing unevenness arose at the time of printing the paste, and a thickness of the internal electrode layer became uneven. When using “good” internal electrode paste, little dripping and blurring, etc. were found, and no printing unevenness was observed at the time of printing the paste, and a thickness of an internal electrode paste became uniform.

[Range of Ac/(Ac+Bu)]

Examples, wherein a polymerization degree or a binder is 2600 (examples 1, 22, 6, 9, 12 and 25), were compared with comparison examples (comparative examples 4 and 8). Internal electrode pastes of these were produced under the same condition other than a value of Ac/(Ac+Bu). As shown in Table 1, in the examples 1, 22, 6, 9, 12 and 25 satisfying 0<Ac/(Ac+Bu)<1.0 and, preferably, 0.3≦Ac/(Ac+Bu)≦0.9, it was confirmed that viscosity of paste was increased comparing with that in the comparative example 4, wherein Ac/(Ac+Bu)=0.0. Also, in the examples 1, 22, 6, 9, 12 and 25, the normal force was in a range of 0.01 to 6.4 kPa, the “dripping degree” was 4 cm²/g or lower and, furthermore, a fluctuation of the adhering quantity of printing was 5% or lower. As a result, internal electrode paste in the examples 1, 22, 6, 9, 12 and 25 exhibited a little dripping and blurring, etc. Also, there was no printing unevenness in the internal electrode layer, and the thickness was uniform (comprehensive evaluation: good). Particularly, among all examples and comparative examples, internal electrode paste in the example 1 exhibited the most excellent printing property.

On the other hand, in the comparative example 4, wherein Ac/(Ac+Bu)=0.0, viscosity was lower comparing with that in the examples 1, 22, 6, 9, 12 and 25. Also, in the comparative example 4, the dripping degree was higher than 4 cm²/g. As a result, in the comparative example 4, printing was impossible and a fluctuation of the adhering quantity of printing was unmeasurable (comprehensive evaluation: defective).

Also, in the comparative example 8, wherein Ac/(Ac+Bu)=1.0, the normal force became larger than 6.4 kPa comparing with that in the examples 1, 22, 6, 9, 12 and 25. Since the normal force was too large in the comparative example 8, releasability of internal electrode paste was poor in screen printing, and it was difficult for the paste to pass through meshes of the screen. Therefore, a fluctuation of the adhering quantity of printing became higher than 5.0%. As a result, in the comparative example 8, the printing condition cannot be kept constant causing that a thickness of the internal electrode layer became uneven (comprehensive evaluation: defective).

The examples 2, 20, 4, 7, 10 and 23, wherein a polymerization degree of the binder resin was 2400, were compared with the comparative examples 2 and 6.

As shown in Table 1, in the examples 2, 20, 4, 7, 10 and 23, wherein 0<Ac/(Ac+Bu)<1.0, and preferably, 0.3≦Ac/(Ac+Bu)≦0.9, viscosity of the paste was confirmed to be increased comparing with that in the comparative example 2, wherein Ac/(Ac+Bu)=0.0. Also, in the examples 2, 20, 4, 7, 10 and 23, the normal force was in a range of 0.01 to 6.4 kPa, the “dripping degree” was 4 cm²/g or lower, and furthermore, a fluctuation of the adhering quantity of printing was 5% or lower. As a result, in the internal electrode paste in the examples 2, 20, 4, 7, 10 and 23, dripping and blurring, etc. of the paste were a little at printing. Also, obtained internal electrode layers had no printing unevenness and a uniform thickness (comprehensive evaluation: good).

On the other hand, in the comparative example 2, wherein Ac/(Ac+Bu)=0.0, the viscosity was lower comparing with that in the examples 2, 20, 4, 7, 10 and 23. Also, in the comparative example 2, the dripping degree was higher than 4 cm²/g. As a result, in the comparative example 2, printing was impossible, and a fluctuation of the adhering quantity of printing was unmeasurable (comprehensive evaluation: defective).

Also, in a comparative example 6, wherein Ac/(Ac+Bu)=1.0, the normal force became larger than 6.4 kPa. Due to the excessive normal force, in the comparative example 6, releasability of the internal electrode paste was poor in screen printing, and it became difficult for the paste to smoothly pass through the meshes of the screen. Therefore, a fluctuation of the adhering quantity of printing became higher than 5.0%. As a result, in the comparative example 6, the printing condition was not kept constant, and a thickness of the internal electrode layer was uneven (comprehensive evaluation: defective).

The examples 3, 21, 5, 8, 11 and 24, wherein a polymerization degree of the binder resin was 2500, were compared with the comparative examples 3 and 7.

As shown in Table 1, in the examples 3, 21, 5, 8, 11 and 24, wherein 0<Ac/(Ac+Bu)<1.0 and, preferably, 0.3≦Ac/(Ac+Bu)≦0.9, viscosity of the paste was confirmed to be increased compared with that in the comparative example 3, wherein Ac/(Ac+Bu)=0. Also, in the examples 3, 21, 5, 8, 11 and 24, the normal force was in a range of 0.01 to 6.4 kPa, the “dripping degree” was 4 cm²/g or lower, and a fluctuation of the adhering quantity of printing was 5% or lower. As a result, in the internal electrode paste in the examples 3, 21, 5, 8, 11 and 24, dripping and blurring, etc. of the paste were a little at printing. Also, obtained internal electrode layers had no printing unevenness and a uniform thickness (comprehensive evaluation: good).

On the other hand, in the comparative example 3, wherein Ac/(Ac+Bu)=0.0, the viscosity was lower comparing with that in the examples 3, 21, 5, 8, 11 and 24. Also, in the comparative example 3, the dripping degree was larger than 4 cm²/g. As a result, in the comparative example 3, printing was impossible, and a fluctuation of the adhering quantity of printing was unmeasurable (comprehensive evaluation: defective).

Also, in the comparative example 7, wherein Ac/(Ac+Bu)=1.0, the normal force became larger than 6.4 kPa comparing with that in the examples 3, 21, 5, 0, 11 and 24. Due to the excessive normal force, in the comparative example 7, releasability of the internal electrode paste was poor in screen printing and, it became difficult for the paste to smoothly pass through the meshes of the screen. Therefore, a fluctuation of the adhering quantity of printing became higher than 5.0%. As a result, in the comparative example 7, the printing condition was not kept constant, and a thickness of the internal electrode layer was uneven (comprehensive evaluation: defective).

As shown in Table 1, in the comparative examples 1 to 5, wherein a polyvinyl butyral resin (Ac/(Ac+Bu)=0) was used as the binder resin, there was a tendency that viscosity of the internal electrode paste became high when increasing a polymerization degree of the resin. However, the dripping property was not sufficiently improved even when the polymerization degree was increased to 3000 or higher, and the “dripping degree” was larger than 4 cm²/g in all of the comparative examples 1 to 5. As a result, in the comparative examples 1 to 5, paste with a preferable printing property could not be obtained (comprehensive evaluation: defective).

As shown in Table 1, in the comparative examples 6 to 8, wherein a polyvinyl acetal resin (Ac/(Ac+Bu)=1.0) was used as the binder resin, it was learnt that viscosity of the paste became high by increasing the polymerization degree, and that dripping of the paste hardly arose at printing (the dripping degree was 4 cm²/g or lower). However, it was confirmed that the normal force became larger than 6.4 kPa, and that the adhering quantity of printing was susceptible to a squeegee speed at printing (a fluctuation of the adhering quantity of printing was higher than 5%). As a result, in the comparative examples 6 to 8, it was difficult to print the internal electrode paste uniformly without any printing unevenness (comprehensive evaluation: defective).

[Polymerization Degree of Binder Resin]

As shown in Table 1, in all of the examples 1 to 12 and 20 to 25, wherein a polymerization degree of the binder resin was 2400 to 2600, the normal force was in a range of 6.01 to 6.4 kPa, the “dripping degree” was 4 cm²/g or lower, and a fluctuation of the adhering quantity of printing was 5% or lower. As a result, in the internal electrode paste in the examples 1 to 12 and 20 to 25, dripping and blurring, etc. of paste at printing was a little. Obtained internal electrode layers had no printing unevenness, and the thickness was uniform as well (comprehensive evaluation: good).

[Content Ratio of Electrode Material Powder]

As shown in Table 2, the examples 13 to 19, wherein a content ratio of the electrode material powder in the internal electrode paste was 30 to 55 wt %, exhibited a little dripping and blurring, etc. at printing. Also, obtained internal electrode layers had no printing unevenness, and the thickness was uniform. Particularly, it was confirmed that the internal electrode layer could be made as thin as a printing thickness of 1.0 μm or thinner when the content ratio of the electrode material powder was 45 wt % or lower.

Also, as shown in Table 2, it was confirmed that the printing thickness of an internal electrode layer and a thickness of an internal electrode layer in a capacitor could be made thinner as the content ratio of the electrode material powder was decreased. Furthermore, it was confirmed that it became difficult to obtain a thinner internal electrode layer as the content ratio of the electrode material powder (conductive material) decreases.

What is claimed is:

1. Internal electrode paste, comprising
an electrode material powder,
a solvent, and
a binder resin;
wherein a molecular structure of said binder resin comprises both of a first structure unit expressed by the chemical formula (I) below and a second structure unit expressed by a chemical formula (II) below.

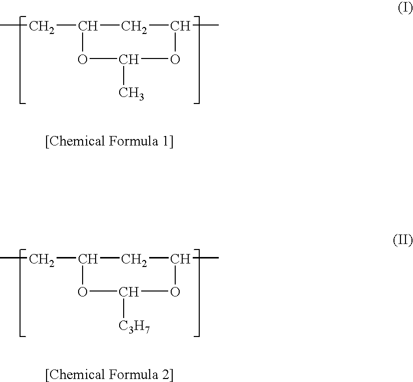

2. The internal electrode paste as set forth in claim 1, wherein
mole % Ac of said first structure unit and mole % Bu of said second structure unit in said binder resin satisfy
a relationship of 0<Ac/(Ac+Bu)<1.0.

3. The internal electrode paste as set forth in claim 1, wherein
mole % Ac of said first structure unit and mole % Bu of said second structure unit in said binder resin satisfy
a relationship of 0.3≦Ac/(Ac+Bu)≦0.9.

4. The internal electrode paste as set forth in claim 1, wherein a polymerization degree of said binder resin is 2400 to 2600.

5. The internal electrode paste as set forth in claim 1, wherein a content ratio of said electrode material powder in said internal electrode paste is 30 to 55 wt %.

6. The internal electrode paste as set forth in claim 1, wherein an acetalization degree indicating a content ratio of said first structure unit and said second structure unit in said binder resin is 60 to 82 mole %.

7. The internal electrode paste as set forth in claim 1, wherein a content of said binder resin in said internal electrode paste is 2 to 5 parts by weight per 100 parts by weight of said electrode material powder.

8. The internal electrode paste as set forth in claim 1, wherein said electrode material powder includes Ni.

9. The internal electrode paste as set forth in claim 1, wherein said solvent includes dihydroterpineol or terpineol.

10. The internal electrode paste as set forth in claim 1, wherein
when a shear rate for said internal electrode paste is 1000 to 10000 [1/s],
a normal force by the Weissenberg effect of said internal electrode paste is 0.01 to 6.4 kPa.

11. The internal electrode paste as set forth in claim 1, wherein an average particle diameter of said electrode material powder is 0.01 to 0.3 μm.

12. The internal electrode paste as set forth in claim 1, comprising a plasticizer,
wherein a content of said plasticizer in said internal electrode paste is 25 to 100 parts by weight per 100 parts by weight of said binder resin.

13. The internal electrode paste as set forth in claim 1, wherein said plasticizer is dioctyl phthalate.

14. The internal electrode paste as set forth in claim 1, comprising a ceramic powder.

15. The internal electrode paste as set forth in claim 14, wherein said ceramic powder includes barium titanate.

16. A multilayer ceramic electronic device produced by using the internal electrode paste as set forth in claim 1.

17. A production method of a multilayer ceramic electronic device, comprising the steps of:
preparing the internal electrode paste as set forth in claim 1;
molding a green sheet;
forming an internal electrode layer by using said internal electrode paste;
obtaining a green chip by stacking said green sheets and internal electrode layers; and
firing said green chip.
